(19) United States
(12) Patent Application Publication
(10) Pub. No.: US 2021/0153306 A1
(43) Pub. Date: May 20, 2021

(54) HEATING MODULE

(71) Applicant: Mahle International GmbH, Stuttgart (DE)

(72) Inventors: Stefan Boegershausen, Stuttgart (DE); Marcel Huelss, Stuttgart (DE); Falk Viehrig, Stuttgart (DE); Robin Wanke, Stuttgart (DE)

(21) Appl. No.: 16/950,848

(22) Filed: Nov. 17, 2020

(30) Foreign Application Priority Data
Nov. 18, 2019 (DE) 102019217690.9

(51) Int. Cl. H05B 3/26; H05B 3/40; H05B 1/02; H01C 7/00

(52) U.S. Cl. CPC H05B 3/265; H05B 3/40; H05B 2203/02; H01C 7/008; H05B 1/0297

(57) ABSTRACT

The present invention relates to a heating module (14) with at least one PTC thermistor element (2) and at least one heating element (15), which is different from a PTC thermistor element (2), wherein the heating element (15) and the PTC thermistor element (2) are connected electrically in series. A simplified and cost-effective production and/or operation of the heating module (14) materialise in that the heating element (15) is thermally connected to the PTC thermistor element (2) in a heat-transferring manner and an electric current density through the PTC thermistor element (2) is lower than the electric current density through the heating element (15).

The invention, furthermore, relates to a heating device (31) having at least one such heating module (14).

### CROSS-REFERENCE TO RELATED APPLICATIONS

This application claims priority to German Patent Application No. DE 10 2019 217 690.9, filed on Nov. 18, 2019, the contents of which is hereby incorporated by reference in its entirety.

### TECHNICAL FIELD

The present invention relates to a heating module, in particular for heat transfer to a fluid, having at least one PTC thermistor element and at least one electric heating element that is different from a PTC thermistor element. The invention furthermore relates to a heating device having such a heating module.

### BACKGROUND

PTC thermistor elements, also known as Positive Temperature Coefficient elements or PTC elements in brief, are increasingly used in heating modules for heating a fluid or an object. This is due in particular to the electrical resistance of PTC thermistor elements which increases with rising temperature, resulting in a maximum temperature of the PTC thermistor element, especially when a constant electric voltage is applied.

Usually, during the operation, such a PTC thermistor element initially passes through a so-called Negative Temperature Coefficient range, hereinafter also referred to as the NTC range. In the NTC range, the electrical resistance of the PTC thermistor element initially decreases with increasing temperature until a minimum electrical resistance of the PTC thermistor element is reached at an initial temperature of the PTC thermistor element. From this minimum electrical resistance, the electrical resistance increases with rising temperature, so that the PTC thermistor element is operated in the PTC range. In the NTC range, therefore, the electric current through the PTC thermistor element initially increases, especially with a constantly applied electric voltage, and then decreases in the PTC range as the temperature rises. The transition between the NTC range and the PTC range is also called the changeover point of the PTC thermistor element. During the transition and at the changeover point, peaks in the electric current and voltage occur, particularly due to the given capacitances and inductances. These peaks can result in damage in the heating module and/or in other components electrically connected to the heating module. As a result, both the heating module and the said components are designed to withstand the said current peaks and voltage peaks. This results in an increased effort and costs in the production of the heating module and/or the said components.

Such heating modules are used in particular in motor vehicles. The heating module can be operated with the mains voltage of the motor vehicle, which for example is in the range of 12V. In an increasing number of motor vehicles, in particular at least partially electrically operated motor vehicles, e.g. hybrid vehicles and/or electric vehicles, electric voltages are present which are many times higher. These voltages are usually above 100V, in particular around several hundred V, for example between 300V and 1,000V, in particular between 400V and 800V. The aim here is to operate the heating module and in particular the PTC thermistor element with the higher voltages, for example in order to increase the output of the heating module and/or simplify the integration of the heating module in the motor vehicle.

However, the increased electric voltage causes the above described current and/or voltage peaks to occur more frequently and can result in increased damage to the heating module or components electrically connected to the heating module. The design of the heating module and the said components to prevent damage therefore becomes more complex and more expensive.

Such heating modules are usually designed to provide a maximum heat output, which is specified. The maximum heat output is usually selected in such a way that the heating module provides sufficient heat or heat output even under extreme conditions. These maximum requirements result in a corresponding design of the PTC thermistor elements of the heating module, which in turn result in an increase of the current peaks and/or voltage peaks described above. This also leads to a complex and expensive production of the heating module and components electrically connected to the heating module.

The current peaks and voltage peaks that occur also result in an increased effort in operating the heating module.

In order to reduce such current peaks, DE 10 2017 218 899A1 proposes to provide several heating stages connected in parallel in a heating device, wherein a PTC thermistor element and an inductive heating element are connected in series in the respective heating stage. The inductive heating element reduces the capacitive inrush current of the PTC thermistor element connected in series with the inductive heating element, so that the capacitively induced current peaks are reduced.

Nevertheless, current peaks do occur in the heating device known from the prior art, especially with increased operating voltage, which render the production and operation of the heating device expensive and complex.

### SUMMARY

The present invention therefore deals with the object of stating improved or at least other embodiments for a heating module of the type mentioned above and for a heating device having such a heating module, which are characterized in particular by a simplified and/or cost-effective manufacture and/or by a simplified operation.

According to the invention, this problem is solved through the subject matter of the independent claim(s). Advantageous embodiments are subject matter of the dependent claim(s).

The present invention is based on the general idea of connecting the heating element and the PTC thermistor element to one another in a heat-transferring manner electrically in series in a heating module comprising a PTC thermistor element and an electric heating element, different from the PTC thermistor element. The thermal connection between the heating element and the PTC thermistor element is such that the heating element is used to overcome the so-called Negative Temperature Coefficient range, hereinafter also referred to as the NTC range in brief, of the PTC thermistor element, so that during the operation the PTC thermistor element is first heated with the heating element in order to reach a temperature that is equal to or higher than a so-called initial temperature of the PTC thermistor element at which the PTC thermistor element exhibits a minimum electrical resistance. In this way, it is thus avoided that the PTC thermistor element generates electric current peaks and/or voltage peaks during the operation at the transition between the NTC range and the range in which the electrical resistance increases with rising temperature, i.e. the Positive Temperature Coefficient range, hereinafter also referred to as the PTC range. This results in that the heating module can be simplified and/or manufactured more cost-effectively due to the reduced electric loads. In addition, the heating module can be operated in a simplified manner in this way. Furthermore, the electrical series connection of the heating element with the PTC thermistor element means that, particularly with a constant applied electric voltage, the increasing electrical resistance of the PTC thermistor element in the PTC thermistor range leads to a reduction in the electric current flowing through the series connection, so that the heat generated with the heating module is reduced. The reduced heat leads to a reduction of the electrical resistance of the PTC thermistor element, so that, especially at constant electric voltage, the current increases, so that in turn more heat can be generated. In other words, with the series connection, an operating temperature range can be specified by an appropriate design of the PTC thermistor element, within which the heating module is operated in a self-regulating manner, in particular at a constant electric voltage. This substantially simplifies the operation of the heating module.

According to the inventive idea, the heating module comprises the PTC thermistor element and the electric heating element, which is different from a PTC thermistor element. The PTC thermistor element, also called Positive Temperature Coefficient element or PTC element in short, and the heating element are electrically connected in series. According to the invention, the PTC thermistor element and the heating element are thermally connected to one another in a heat-transferring manner. In addition, the PTC thermistor element and the heating element are designed in such a way that during the operation an electric current density through the at least one PTC thermistor element is lower than the electric current density through the at least one heating element. The low electric current density through the PTC thermistor element means that the heat generated with the heating module originates predominantly from the heating element and also means that the PTC thermistor element itself does not generate any or no significant heat, particularly in the NTC region or at the transition between the NTC region and the PTC region. This results in the prevention or at least reduction of the mentioned current and/or voltage peaks.

The heat-transferring connection between the heating element and the PTC thermistor element is practical in such a manner that the temperature of the PTC thermistor element substantially corresponds to the temperature of the heating element. Substantially here means in particular that the equalisation of the temperatures of the PTC thermistor element and of the heating element due to the heat transfer is not instantaneous.

In particular, the PTC thermistor element has a characteristic and temperature-dependent curve of the electrical resistance as shown in FIG. 1. Accordingly, the electrical resistance initially decreases as the temperature rises until the electrical resistance at the initial temperature reaches a minimum value. The temperature range up to the initial temperature or the corresponding decrease in electrical resistance is called the NTC range. With increasing temperature, the electrical resistance rises so that the range above the initial temperature is called the PTC range. When the temperature continues to rise starting from the initial temperature, the electrical resistance increases up to a nominal temperature at which the PTC element has a nominal resistance. Above the nominal resistance, the electrical resistance increases more slowly. At a final temperature of the PTC thermistor element, the increase in the electrical resistance of the PTC thermistor element increases starting from a final electrical resistance corresponding to the final temperature with a significant reduction. The range between the initial temperature and the final temperature is the working range of the PTC thermistor element.

The heating element that is different from a PTC thermistor element means in this case that the heating element does not have the resistance curve through the NTC range and the PTC range that is characteristic for a PTC thermistor element. In particular, the heating element is free of PTC thermistors or free of a PTC thermistor element.

The heating element is for example a resistance heater, a heating wire, a thick-film heater and the like.

The solution according to the invention allows the heating module to be provided in different shapes and/or sizes. The heating module can be designed in particular in the form of a rod, i.e. especially as a heating rod.

The current density through the PTC thermistor element is realised, for example, by appropriate dimensioning of the PTC thermistor element. In particular, the PTC thermistor element can be designed with a larger cross section through which electric current can flow in order to reduce the current density.

Preferred are embodiments in which the PTC thermistor element and the heating element are designed in such a way that the electric current density through the PTC thermistor element is at least ten times lower than the electric current density through the heating element.

Preferred are embodiments, in which a maximum operating temperature is specified for the heating module, wherein the maximum operating temperature lies between an initial temperature and a final temperature of the PTC thermistor element. Thus, the maximum operating temperature of the heating module is achieved by an appropriate design of the PTC thermistor element, so that the heating module can be manufactured and/or operated cost-effectively and easily. The maximum operating temperature is for example a temperature up to which the heating module and/or adjacent components can be operated without damage.

Preferred are embodiments, in which the nominal temperature of the PTC thermistor element is equal to or higher than the maximum operating temperature. In particular, the maximum operating temperature corresponds to the nominal temperature of the PTC thermistor element. At the nominal temperature, there is a sudden increase of the electrical resistance of the PTC thermistor element. It is therefore also possible to operate the heating module reliably and simplified and/or to manufacture it more cost-effectively. Furthermore, it is thus possible to employ the PTC thermistor element between the initial temperature and the nominal temperature to provide a heat output of the heating module.

In principle, the heat-transferring connection between the PTC thermistor element and the heating element can be configured as desired. In particular, the heat-transferring connection between the PTC thermistor element and the heating element is realised by means that are different from a simple electrical connection, for example through a cable, a stranded wire and the like, and/or a pure convection and/or a pure heat radiation.

It is conceivable that the PTC thermistor element and the heating element lie directly against one another and are thus connected to one another both thermally in a heat-transferring manner and also electrically.

Alternatively or additionally, the heating module can comprise a body that is separate from the PTC thermistor element and the heating element for the heat transfer between the heating element and the PTC thermistor element, in the following also referred to as heat transfer body.

The heat transfer device (heat exchanger) is preferentially areally connected to the PTC thermistor element and the heating element in a heat-transferring manner in order to thus interconnect these in a thermally heat-transferring manner. In particular it is conceivable that the heat transfer body lies flat against the PTC thermistor element and/or the heating element.

In principle, the heat transfer body can have any shape and/or extension.

Obviously, the heating module can also comprise two or more heat transfer bodies.

Conceivable are embodiments, in which at least one of the heat transfer bodies is formed as a plate. It is thus possible to produce the heating module in an installation space-saving manner and at the same time with a high heat transfer rate between the PTC thermistor element and the heating element. In particular it is thus possible to arrange the PTC thermistor element and the heating element between two such plates.

Alternatively or additionally it is conceivable that at least one of the heat transfer bodies is designed as a ceramic. In particular it is conceivable that at least one of the at least one heat transfer body is a ceramic plate. Thus, in addition to an advantageous heat-transferring connection between the PTC thermistor element and the heating element, an electrical insulation of the heating module is achieved, in particular to the outside.

Alternatively or additionally it is conceivable to integrate the PTC thermistor element and the heating element in at least one such ceramic plate in such a way that the PTC thermistor module and the heating module are accommodated in the ceramic plate.

It is also conceivable to provide a ceramic body as heat transfer body, in which the PTC thermistor element and the heating element are embedded.

It is conceivable to arrange the PTC thermistor element and the heating element next to one another in one direction of the heating module, hereinafter also referred to as adjacent direction, and to arrange such a plate in a direction transverse to the adjacent direction, which is arranged adjacent to the PTC thermistor element and the heating element. The plate is preferably electrically insulating in order to electrically insulate the PTC thermistor element and the heating element from the outside. The plate may be in particular the said ceramic plate.

It is to be understood that the heating module can also have two or more heating elements, each of which is different from a PTC thermistor element. It is conceivable that the heating module comprises two or more PTC thermistor elements that are different from one another. At least one heating element and at least one PTC thermistor element are connected to one another in a heat-transferring manner and are electrically connected in series. Particularly preferably, all of the at least one PTC thermistor element and all of the at least one PTC thermistor element are connected in series and to one another in a heat-transferring manner.

The heating module can be used to heat any object and/or any fluid. In particular, the heating module is used to heat a fluid, for example air or a coolant.

It is to be understood that beside the heating module a heating device having such a heating module is also part of the subject-matter of this invention.

The heating device can serve for heating a fluid. For this purpose, a flow path of the fluid leads through the heating device, wherein the heating module is heat-transferringly connected to the flow path, so that the heating module heats the fluid during the operation. In particular, the heating module is arranged in the flow path of the fluid.

The heating device can comprise two or more such heating modules, which are each heat-transferringly connected to the flow path, in particular are arranged in the flow path.

It is conceivable to arrange between two such heating modules a structure through which the fluid can flow, for example a grid and/or a fin structure. By way of this, the heat-transferring surface is enlarged. As a consequence, the fluid is heated more efficiently.

Further important features and advantageous of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters numbers relate to same or similar or functionally same components.

### BRIEF DESCRIPTION OF THE DRAWINGS

It shows, in each case schematically

FIG. 1 shows a characteristic curve of a PTC thermistor element,

FIG. 2 shows a section through a heating module,

FIG. 3 shows another section through the heating module,

FIG. 4 shows the view from FIG. 3 in another exemplary embodiment of the heating module,

FIGS. 5 and 6 show an equivalent circuit diagram of the heating module each,

FIG. 7 shows a highly simplified sectional representation of a heating device with the heating module,

FIG. 8 shows an equivalent circuit diagram of the heating module in a further exemplary embodiment.

### DETAILED DESCRIPTION

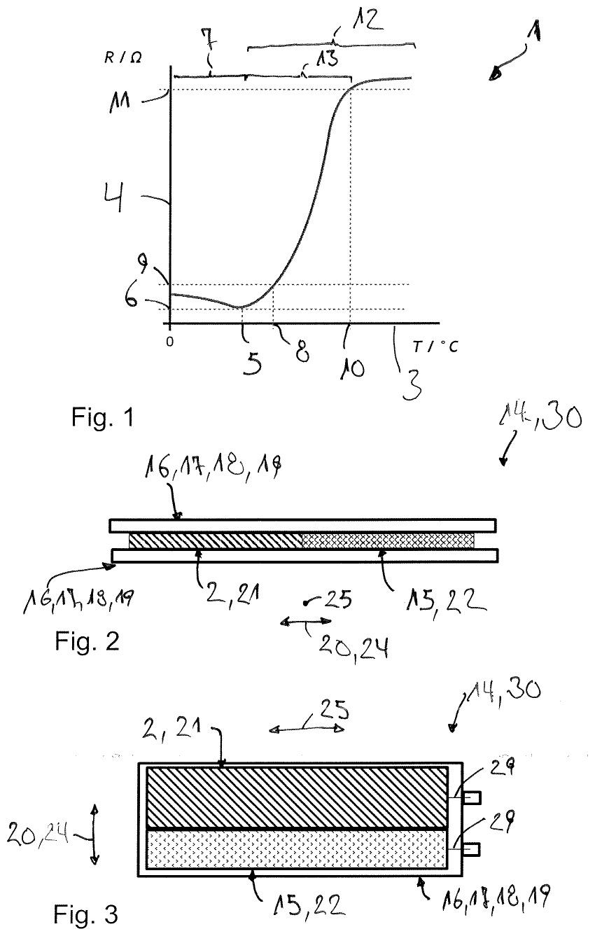

FIG. 1 shows a characteristic curve 1 of a PTC thermistor element 2, such as is shown for example in the FIGS. 2 to 7. The PTC thermistor element 2, also referred to as Positive Temperature Coefficient element 2 or PTC element 2 in brief, has a temperature-dependent electrical resistance according to FIG. 1. Here, the temperature and the electrical resistance are plotted on a logarithmic scale on the abscissa axis 3 and on the coordinate axis 4 respectively in FIG. 1. Accordingly, the electrical resistance of the PTC thermistor element 2 initially drops with rising temperature until at an initial temperature 5 a minimum resistance 6 of the PTC thermistor element 2 is reached. The temperature range up to the initial temperature 5 of the PTC thermistor 2 is referred to as Negative Temperature Coefficient range 7, also referred to as NTC range 7 in brief. At temperatures above the initial temperature 5, the electrical resistance greatly rises up to a nominal temperature 8, at which the PTC thermistor element 2 has a nominal resistance 9. The greater increase of the electrical resistance between the initial temperature 5 and the nominal temperature 8 is followed by a less pronounced increase of the electrical resistance between the nominal temperature 8 and a final temperature 10, at which the PTC thermistor element 2 has a final resistance 11. From the final temperature 10, the characteristic of the electrical resistance changes, wherein the final temperature 10 or the final resistance 11 forms a turning point of the characteristic curve 1. The range above the initial temperature 5 is referred to as Positive Temperature Coefficient range 12, in the following also referred to as PTC range 12 in brief. The temperature range between the initial temperature 5 and the final temperature 10 is the working range 13 of the PTC thermistor element 2. The initial resistance 6 or the initial temperature 5 are the changeover point. This means that the resistance up to the turnover point or up to the initial temperature 5 drops or, provided the PTC thermistor element 2 is connected to a voltage source, the electric current through the PTC thermistor element 2 increases, wherein because of capacitances and inductances the PTC thermistor element 2 peaks in the electric current and the voltage occur in the changeover point or at the initial temperature 5 or the initial resistance 6.

A heating module 14 according to the invention, as is shown in the FIGS. 2 to 7, prevents or reduces the said current peaks and/or voltage peaks. For this purpose, the heating module 14, besides the PTC thermistor element 2, comprises an electric heating element 15 that is different from the PTC thermistor element 2. In particular, the heating element 15 does not exhibit a characteristic curve that is characteristic for a PTC thermistor element 2, as is exemplarily shown in FIG. 1. The heating element 15 is in particular free of a PTC thermistor element 2. The PTC thermistor element 2 and the heating element 15 are electrically series-connected to one another. The PTC thermistor element 2 and the heating element 15 are thus electrically connected in series. The PTC thermistor element 2 and the heating element 15 are configured in such a manner that during the operation an electric current density through the PTC thermistor element 2 is lower than the electric current density through the heating element 15. As is evident in FIG. 3, this can be achieved through a greater dimensioning of the PTC thermistor element 2.

The PTC thermistor element 2 and the heating element 15 are thermally connected to one another in a heat-transferring manner such that the temperature of the PTC thermistor element 2 substantially corresponds to the temperature of the heating element 15. In the shown exemplary embodiments, the heat-transferring connection of the PTC thermistor element 2 to the heating element 5 is effected by way of at least one heat transfer body 16 that is separate from the PTC thermistor element 2 and from the heating element 15. In the shown exemplary embodiment, two such heat transfer bodies 16 each are provided, between which the heating element 15 and the PTC thermistor element 2 are arranged. The shown heat transfer bodies 16 are each formed plate-shaped or as a plate 17. In addition, the heat transfer bodies 16 are electrically insulating in the shown exemplary embodiments. In particular, the heat transfer bodies 16 are formed as a ceramic 18, for example as a ceramic plate 19. Thus, the heat transfer bodies 16 connect the PTC thermistor element 2 heat-transferringly with the heating element 15 and insulate the PTC thermistor element 2 and the heating element 15 electrically to the outside. Here, the PTC thermistor element 2 and the heating element 15 are arranged in the shown examples next to one another in a direction 20, in the following also referred to as adjacent direction 20, wherein the respective heat transfer body 16 transversely to the adjacent direction 20 is adjacent to the PTC thermistor element 2 and the heating element 15. Here, the respective heat transfer body 16 in the shown exemplary embodiments lies flat against the PTC thermistor element 2 and against the heating element 15. In the shown exemplary embodiments, the heating module 2 is thus formed in the manner of a rod 30, in the following also referred to as heating rod 30.

In the shown exemplary embodiments, the respective PTC thermistor element 2 is formed rectangular and in the manner of a brick. In particular, the respective PTC thermistor element 2 is formed as a so-called PTC thermistor brick 21, in the following also referred to as PTC brick 21.

In the exemplary embodiments shown in the FIGS. 2 and 3, the PTC thermistor element 2 and the heating element 15 lie directly against one another and are thus additionally heat-transferringly connected to one another. Through the contact, the PTC thermistor element 2 and the heating element 15 are additionally electrically connected to one another. In this exemplary embodiment, the heating element 15 is a thick film heater 22 which is designed brick-shaped or rectangular.

Here, FIG. 2 shows a first section through the heating module 14 and FIG. 3 a second section through the heating module 14 running transversely to the first section. In FIG. 3, the section runs through the PTC thermistor element 2 and the heating element 15, so that one of the heat transfer bodies 16 is not visible. According to these figures, the PTC thermistor element 2 and the heating element 15 in this exemplary embodiment are arranged along a transverse direction 24 of the heating module 14 next to one another. Accordingly, the adjacent direction 20 runs parallel to the transverse direction 24, corresponds in particular to the transverse direction. Here, the PTC thermistor element 2 and the heating element 15 extend longitudinally in a longitudinal direction 25 running transversely to the transverse direction 24.

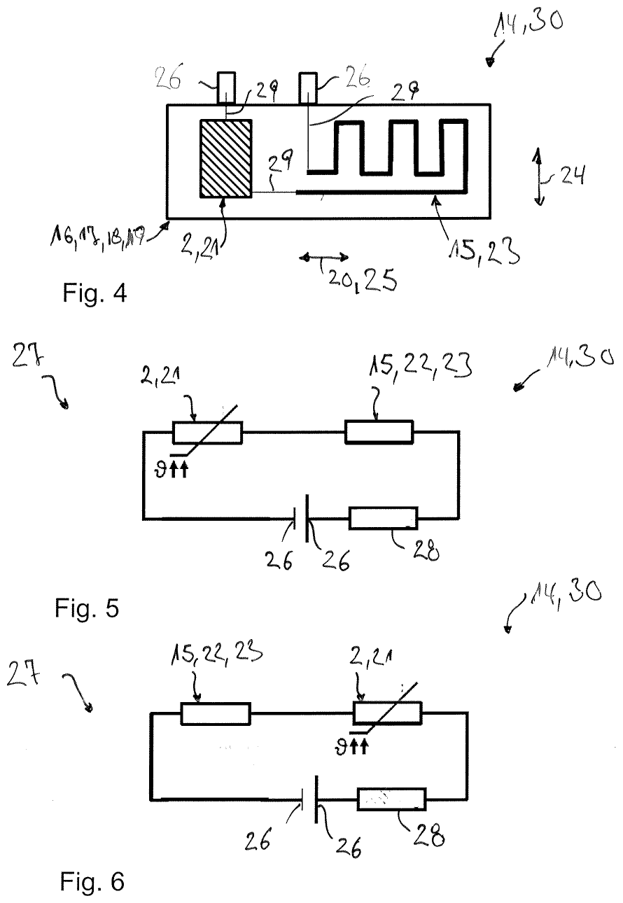

FIG. 4 shows another exemplary embodiment of the heating module 2, wherein in FIG. 4 the section according to FIG. 3 is shown. This exemplary embodiment differs from the exemplary embodiment shown in the FIGS. 2 and 3 in that the PTC thermistor element 2 and the heating element 15 are spaced apart from one another. In addition, the heating element 15 is formed as a resistance heater 23 which runs meander-like. In the exemplary embodiment shown in FIG. 4, the PTC thermistor element 2 and the heating element 15 are arranged adjacent in the longitudinal direction 25. The adjacent direction 20 thus runs parallel to the longitudinal direction 25, corresponds in particular to the longitudinal direction 25.

In the shown exemplary embodiments, the respective heating module 2 comprises two electrical connections 26, via which the PTC thermistor element 2 and the heating element 15 are supplied electrically.

In the exemplary embodiment of the FIGS. 2 and 3, the connections 26 are merely shown in FIG. 3. In this exemplary embodiment, the connections 26 are purely exemplarily arranged on the end side in the longitudinal direction 25. In the exemplary embodiment of FIG. 4, the connections 26 are purely exemplarily arranged on the end side in the transverse direction 24.

The FIGS. 5 and 6 each show an equivalent circuit diagram 27 of the heating module 2 from the FIGS. 2 to 4, wherein the heating modules 2 or equivalent circuit diagrams 27 differ by the arrangement of the PTC thermistor element 2 relative to the heating element 15. The PTC thermistor element 2 has an electrical resistance with a characteristic curve as explained in FIG. 1. The heating element 15 likewise comprises an electrical resistance. In the FIGS. 5 and 6 an equivalent resistance 28 of the electrical lines 29 of the PTC thermistor element 2 and of the heating element 15 with the connections 26 or among one another is additionally taken into account. The total resistance of the heating module 2 thus corresponds to the sum of the resistances of the PTC thermistor element 2, of the heating element 15 and of the equivalent resistance 28 for the lines 29.

When a, in particular constant, electric voltage is applied to the heating module 2, heat is predominantly generated with the heating element 15 because of the low current density through the PTC thermistor element 2. Because of the heat-transferring thermal connection between the heating element 15 and the PTC thermistor element 2, the PTC thermistor element 2 is heated at the same time without the PTC thermistor element 2 generating the said current peaks and/or voltage peaks or these peaks are at least reduced. In other words: the transition or the changeover point of the PTC thermistor element 2 is overcome without the PTC thermistor element 2 causing the peaks in the electric current or the voltage that are typical in the prior art or these peaks are at least reduced. Here, the PTC thermistor element 2 and the heating element 15 are matched to one another and thermally connected to one another in such a manner that the heat generated in the heating module 2, up to a temperature that is equal to or greater than the initial temperature 5 of the PTC thermistor element 2, is predominantly or exclusively generated by the heating element 15. The heating operation within the PTC thermistor element 2 thus commences only when the PTC thermistor element 2 already has a temperature that is above the initial temperature 5, preferably is between the initial temperature 5 and the final temperature 10. Thus, the NTC range 7 of the PTC thermistor element 2 is bridged or skipped.

With increasing heat output of the heating module 2 and thus with increasing temperatures, the resistance of the PTC thermistor element 2 increases so that in particular at a constant applied electric voltage, the electric current flowing through the heating element 15 and the PTC thermistor element 2 decreases. This in turn leads to a reduction of the heat output of the heating element 15 and thus of the temperature. With decreasing temperature, the electrical resistance of the PTC thermistor element 2 and thus of the entire heating module 2 decreases, which leads to an increase of the electric current through the PTC thermistor element 2 and through the heating element 15 and consequently higher temperatures. Thus, a self-regulation of the heating module 2 is achieved.

The initial temperature 5 and the working range 13 of the PTC thermistor element 2 are preferentially selected in such a manner that the maximum permissible operating temperature of the heating module 2 between the initial temperature 5 and the final temperature 10 is preferentially slightly higher than the initial temperature 5 up to the final temperature 10. In particular it can be provided that the maximum operating temperature corresponds to the nominal temperature 8 of the PTC thermistor module.

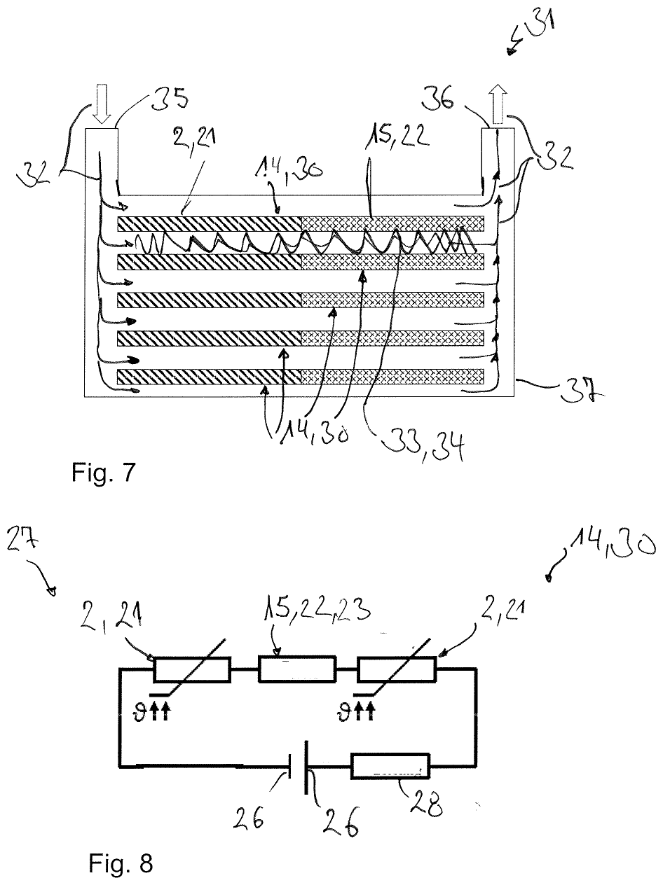

FIG. 7 shows a highly simplified representation of a heating device 31 in section. Accordingly, the heating device 31 can serve for heating a fluid, whose flow path 32 indicated by arrows leads through the heating device 31. Furthermore, the heating device 31 comprises at least one heating module 14 which is heat-transferringly connected to the flow path 32 so that the heating module 2 heats the fluid during the operation. In the example shown in FIG. 7, multiple such heating modules 2 are provided, which are arranged spaced apart from one another. Here, the heating modules 14 are each arranged in the flow path 32 in such a manner that the flow path 32 runs between the consecutive heating modules 2. Between the adjacent heating modules 14, a structure 33, as exemplarily shown for two of the heating modules 14 in FIG. 7, in particular a fin structure 34 or a grid 38 can be arranged, through which the fluid can flow, through which thus the flow path 32 leads and with which the total heat-transferring surface is enlarged. In the exemplary embodiment shown in FIG. 7, the heating device 31, furthermore, comprises an inlet 35 for letting the fluid into the heating device 31 and an outlet 36 for letting the fluid out of the heating device 31. Furthermore, the heating device 31 can comprise a housing 37 in which the heating modules 14 are arranged and through which the flow path 32 leads. Here, merely the PTC thermistor element 2 and the heating element 15 of the respective heating module 14 are shown in the exemplary embodiment of FIG. 7, the heating element 15 being the thick-film heater 22. The heating modules 2 are thus in particular heating modules 14 such as shown in the FIGS. 2 and 3. Obviously, heating modules 14 of the exemplary embodiment in FIG. 4 can also be employed. It is also conceivable to provide at least two different heating modules 14.

In the exemplary embodiment shown in the FIGS. 2 to 7, the respective heating module 14 comprises a single PTC thermistor element 2 and a single heating device 15.

As shown in FIG. 8, in which an equivalent circuit diagram 27 of a heating module 2 in another exemplary embodiment is shown, such a heating module 14 can obviously also comprise two or more PTC thermistor elements 2, wherein in the exemplary embodiment shown in FIG. 8 it is assumed that the heating module 14 comprises two PTC thermistor elements 2, between which the heating element 15 is arranged. Here, the heating element 15 is preferably thermally connected to the two PTC thermistor elements 2 in a heat-transferring manner, so that the NTC range 7 of the respective PTC thermistor element 2 is overcome, as described above.

1. A heating module (14), in particular for the heat transfer to a fluid, having at least one PTC thermistor element (2) and at least one electric heating element (15), which is different from a PTC thermistor element (2),
wherein the at least one PTC thermistor element (2) and the at least one heating element (15) are electrically connected to one another in series,
characterized
in that at least one of the at least one heating elements (15) is thermally connected to at least one of the at least one PTC thermistor elements (2) in a heat-transferring manner,
in that the at least one PTC thermistor element (2) and the at least one heating element (15) are configured in such a manner that during the operation an electric current density through the at least one PTC thermistor element (2) is lower than the electric current density through the at least one heating element (15).

2. The heating module according to claim 1,
characterized
in that the current density through the at least one PTC thermistor element (2) is at least ten times lower than the electric current density through the at least one heating element (15).

3. The heating module according to claim 1 or 2,
characterized
in that the heating module (14) has a specified maximum operating temperature,
in that the maximum operating temperature is between an initial temperature (5) and a final temperature (10) of at least one of the at least one PTC thermistor elements (2).

4. The heating module according to claim 3,
characterized
in that a nominal temperature (8) of at least one of the at least one PTC thermistor elements (2) is equal to or higher than the maximum operating temperature.

5. The heating module according to any one of the claims 1 to 4,
characterized
in that at least one of the at least one PTC thermistor elements (2) lies against at least one of the at least one heating elements (15).

6. The heating module according to any one of the claims 1 to 5,
characterized
in that a heat transfer body (16) that is separate from the at least one PTC thermistor element (2) and the at least one heating element (15) is areally connected to at least one of the at least one PTC thermistor elements (2) and at least one of the at least one heating elements (15) in a heat-transferring manner and thus thermally connecting these to one another in a heat-transferring manner.

7. The heating module according to claim 6,
characterized
in that at least one of the at least one heat transfer bodies (16) is formed as a plate (17).

8. The heating module according to claim 6 or 7,
characterized
in that at least one of the at least one heat transfer bodies (16) is formed as a ceramic (18).

9. The heating module according to any one of the claims 1 to 8,
characterized
in that the at least one PTC thermistor element (2) and the at least one heating element (15) are arranged next to one another in an adjacent direction (20),
in that the heating module (14) comprises at least one electrically insulating plate (17), which is arranged transversely to the adjacent direction (20) adjacent to at least one of the at least one PTC thermistor elements (2) and at least one of the at least one heating elements (15).

10. A heating device (31) for heating a fluid, wherein a flow path (32) of the fluid leads through the heating device (31) and having at least one heating module (14) according to any one of the claims 1 to 9 which is heat-transferringly connected to the flow path (32), so that the heating module (14) heats the fluid during the operation.
